(19) United States
(12) Patent Application Publication
(10) Pub. No.: US 2004/0193493 A1
(43) Pub. Date: Sep. 30, 2004

(54) Advertising system and method

(76) Inventor: Budde B. King, Sun City West, AZ (US)

Correspondence Address: Michael W. Goltry, PARSONS & GOLTRY, Suite 260, 340 East Palm Lane, Phoenix, AZ, 85004, US

(21) Appl. No.: 10/818,270

(22) Filed: Apr. 5, 2004

Related U.S. Application Data
(63) Continuation of application No. 09/415,470, filed on Oct. 8, 1999.

(51) Int. Cl. G06F 17/60

(52) U.S. Cl. 705/14

(57) ABSTRACT

In a theatre including spectators observing participants engaged in an activity, a method of exploiting at least one of the participants for facilitating a beneficial commercial impression in at least one of the spectators during the activity, the method comprising the steps of gathering a still digital image of one of the participants, storing the still digital image into a memory file of a digital computer, preparing a still digital commercial image with the digital computer incorporating the still digital image, the still digital commercial image capable of evoking a beneficial commercial impression, generating a report of the still digital commercial image, and presenting the report to the spectators.

### FIELD OF THE INVENTION

This invention concerns advertising systems and methods.

### BACKGROUND OF THE INVENTION

To advertise is to make something known for the purpose of arousing the desire to buy or patronize goods or services. The key ingredient for effective advertising is matching an appropriate target audience with specific goods or services. Not every audience will buy or patronize every good or service. Accordingly, having an understanding of the demographics, culture, needs and social-economic base of a given audience can mark the difference between effective and ineffective advertising.

Most advertising methods incorporate press, magazine, billboard, radio and television exposure, which together comprise traditional advertising instrumentalities. Most companies, both large and small, simply budget advertising expenses to include one or more of the traditional advertising instrumentalities. Advertising is an investment. However, business owners often invest little attention toward identifying a potentially quantifiable return on advertising expenditures. This is likely due to the fact that it is difficult, if not impossible, to quantify a return from an investment into traditional advertising instrumentalities. In view of these and other deficiencies in the art of advertising, the need for certain new and useful improvements is evident.

Accordingly, it would be highly desirable to provide a new and improved advertising method and system.

It is a purpose of the invention to provide a new and improved advertising method and system that defines advertising in terms of an investment having a potentially quantifiable return.

It is another purpose of the invention to provide a new and improved advertising method and system that tailors photo-imaging advertising media to meet specific high-volume, mass market customer needs.

It is still another purpose of the invention to provide a new and improved advertising method and system that incorporates real-time public relations, information transfer, visual presentations, and internet website or link imaging content and updates.

It is a further provision of the invention to enable small businesses to significantly level the visual communications playing field with big corporate entities with their vast marketing organizations, subcontracted advertising agencies and public relations firms.

It is still a further provision of the invention to alter the traditional relationship between advertising and professional sporting events.

It is yet still a further purpose of the invention to provide a new and improved advertising method and system that incorporates digital photo imaging and real-time, global communications.

It is yet a further purpose of the invention to provide a useful advertising system that can be applied to any commercial business that incorporates marketing or advertising into business development plans.

It is another provision of the invention to pinpoint targeted newspaper advertising in specific markets.

### SUMMARY OF THE INVENTION

The above problems and others are at least partially solved and the above purposes and others realized in a new and improved advertising method and system. Various permutations of the invention are to be carried out in the environment of a theatre defined as spectators observing participants engaged in an activity such as a sporting event, a political or non-political event, an entertainment event, a scientific, technical or non-technical event, etc. A preferred method of the invention comprises that of exploiting a still image of at least one of the participants, the still image being capable of evoking a beneficial commercial impression in at least one of the spectators during the activity. The method is comprised of the steps of gathering a still digital image of one of the participants, storing the still digital image into a memory file of a digital computer and, with the digital computer, preparing a still digital commercial image incorporating the still digital image. The method next includes the steps of generating a report of the still digital commercial image, and presenting the report to the spectators.

Gathering a still digital image of one of the participants further comprises the steps of providing digital imaging apparatus, directing the digital imaging apparatus toward the one of the participants, and actuating the digital imaging apparatus. The still digital image is stored into a memory file of a digital computer by downloading the still digital image from the digital imaging apparatus to the memory file. First designing it on the digital computer and then providing it in the form of a hard copy or an electronic copy carries out the generation of a report of the still digital commercial image. In one embodiment, presenting the report to the spectators may further include the step of positioning the hard copy so that the spectators present at the sporting event may view it. In another embodiment, presenting the report to the spectators may, in the environment of spectators observing the sporting event by way of one or more remote or on-line data links, comprise the step of posting the electronic report onto one or more of the on-line data links. The on-line data links are internet-based, and may be locally and/or globally linked. To post the electronic report, it must be transferred to the on-line data link over a data transfer link between the digital computer and the on-line data link. The data transfer link may be established as a hard or wired communications or telecommunications link, or a remote or wireless communications or telecommunications link.

### DETAILED DESCRIPTION OF A PREFERRED EMBODIMENT

The field of advertising is very esoteric, often misunderstood, and extremely difficult to isolate in terms of the relationship between advertising expenditures and returns. Most advertising methodologies incorporate rather blind strategies designed to gain public exposure merely by incorporating advertising commercials through press, magazine, billboard, radio, television and yellow page exposure, to name but a few. One specific arena that advertisers focus on in hopes of gaining high levels of product or service exposure is that of professional and amateur sporting events, especially those that are televised. From golf to field events like baseball, basketball, soccer and football to car racing, sporting events draw large crowds of spectators that often represent a broad demographic spectrum. As a result, the cost of advertising during sporting events, whether through television or radio, proves very expensive, and often prohibitively expensive for smaller or less wealthy concerns. Spectators can watch or track most sporting events either at the sporting event, on the television or radio and, with the advent of the internet, by accessing website or internet links covering the sporting events. The television and radio, however, define the primary means for presenting commercial advertising.

In terms of this disclosure, the term advertising may comprise marketing, communications, public relations, publicity, promotions, special events or the like which is specifically designed to make something known for the purpose of arousing the desire to buy or patronize goods or services. Furthermore, any sporting, political, non-political, news, entertainment, scientific, technical, or non-technical event may be referred to as an activity. In this disclosure the terms theatre or arena are each defined as spectators observing participants engaged in an activity. Depending on the activity, the participants may comprise political analysts, politicians, entertainers, scientific or technical professionals, golfers, basketball players, football players, baseball players, soccer players and race care drivers including the racecars they drive. In terms of simple advertising exposure apart from television and radio spots, human participants, especially participants of sporting and entertaining activities, normally wear clothing articles that bear the trademarks of their sponsors. In a similar manner, racecars are virtual billboards, as they are typically decorated with the emblems or advertising indicia of one or more of the companies that sponsor that particular driver. Popular human participants, racecar drivers and their racecars comprise the backbone of advertising. By virtue of often very lucrative contracts, popular human participants allow companies to exploit them for promoting specific goods or services.

Outside of traditional and often considerably expensive advertising methods used during some-activities, especially sporting and entertaining activities, this invention comprises a specific method of exploiting a still image of a participant of an activity, the still image being capable of evoking a beneficial commercial impression in at least one of the spectators observing the sporting event whether in person or over the internet. The term beneficial commercial impression comprises an effect, a feeling, or an image retained as a consequence of experience capable of promoting a favorable result. This favorable result might be increased sales or publicity, technical or non-technical advancements, beneficial contractual relations, etc. The method is carried out with digital apparatus, which provides clear imagery and, in some cases, sound. In a preferred embodiment, the method is carried out at the sporting event and is comprised of the steps of gathering a still digital image of one or more of the participants, storing the still digital image into a memory file of a digital computer. By using the digital computer, the method further includes the steps of preparing a still digital commercial image incorporating the still digital image, the still digital commercial image capable of evoking a beneficial commercial impression, generating a report of the still digital commercial image, and presenting the report to the spectators. Gathering the still digital image is carried out with the use of a convention digital imaging apparatus or camera such as those readily found under the Kodak, Nikon and Canon brand names. The operation of these cameras is very easily carried out, and will not be discussed except to the extent necessary to provide a full disclosure of this invention. To gather or capture a still digital image, one need only direct the digital, imaging apparatus toward a participant and then capture a still digital image of the participant by actuating the digital imaging apparatus. After the still digital image is captured, the step of storing the still digital image into a memory file of a digital computer further includes the step of downloading the still digital image from the digital imaging apparatus to the memory file. This step of downloading is carried out with convention system architectures that are intended to be included within the structure of the digital computer and the digital imaging apparatus. In particular, the conventional digital imaging apparatus of this invention include removable storage cards that house still digital images. These still digital images may be easily downloaded to memory files of a digital computer from the storage cards. After the still digital images have been downloaded into the computer, the old files on the storage cards may be deleted and the storage cards re-used.

The preparation of the still digital commercial image incorporating the still digital image stored in the memory file may be carried out in a user-specific manner with the digital computer. By using the computer, including its output device, which may comprise a computer screen, and its input device, which may comprise a keyboard, the user may produce the still digital commercial image containing not only the still digital image, but also specific advertising indicia promoting a specific good or service. In an electronic format, the advertising indicia may include voice, sound or other audible stimulus. After creating the still digital commercial image, it may be stored into a memory file of the digital computer, and/or converted into a report capable of being presented to the spectators.

The report may comprise a hard copy of the still digital commercial image or an electronic report of the still digital image containing any associated audible or voice data. The hard copy may be generated at the location of the activity with an output device or printer coupled to the computer. The printer may comprise any of a variety of printers, whether multiple or single color, readily available to the skilled artisan. After the hard copy has been generated, it may be held up or displayed at a conspicuous location at the activity so that selected ones or all of the spectators present at the activity may view it. This technique effects real-time and very inexpensive advertising, as it provides a method of exploiting a still image of a participant involved in an activity during the activity for promoting specific goods or services without having to rely on radio and/or television or other form of expensive media coverage. Given the number of spectators reached by this advertising method, returns on the investment to employ the method for advertising to those spectators can be quantified. The number of spectators can be found with conventional counting or ratings techniques. The hard copy may later be submitted to trade, technical, non-technical or sporting magazines and/or one or more newspaper publications.

The electronic report of the still digital commercial image comprises one capable of being viewed and/or heard by way of a computer, including any necessary output devices including but not limited to computer screen and speaker apparatus. In this embodiment, the still digital commercial image is transferred or otherwise posted in a conventional manner to one or more on-line internet web sites or data links engaged in covering the activity as the activity is taking place. The digital computer containing the memory file of the still digital commercial image may be coupled to the internet by way of an established hard wired telecommunication data link or a remote or wireless telecommunication data link. Conventional URL or HTML internet programming schemes may be used for effecting the transfer and posting of the still digital commercial image. By posting or displaying the still digital commercial image on one or more internet web pages or links during the activity and while spectators are observing the activity over one or more of the internet web sites or links, it may be viewed by selected ones or all of the spectators observing the activity over one or more of the internet web sites or links. This technique effects real-time and very inexpensive advertising, as it provides a method of exploiting a still image of a participant involved in an activity during the activity for promoting specific goods or services without having to rely on radio and/or television or other form of expensive media coverage. Given the number of spectators reached by this advertising method, returns on the investment to employ the method for advertising to those spectators can be quantified. The number of spectators can be found by ratings or counting techniques, such as counting how many “hits” an internet web page or link covering an activity receives during an activity. The electronic report may later be submitted to trade, technical, non-technical or sporting magazines and/or one or more newspaper publications.

The present invention has been described above with reference to a preferred embodiment. However, those skilled in the art will recognize that changes and modifications may be made in the described embodiments without departing from the nature and scope of the present invention. Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. In a theatre including spectators observing participants engaged in an activity, a method performed during the activity comprising the steps of:
gathering a still digital image of one of the participants engaged in the activity;
storing the still digital image into a memory file of a digital computer;
with the digital computer, preparing a still digital commercial image incorporating the still digital image, the still digital commercial image capable of evoking a beneficial commercial impression;
generating a report of the still digital commercial image; and
presenting the report to the spectators.

2. The method of claim 1, wherein the step of gathering a still digital image of one of the participants further comprises the steps of:
providing digital imaging apparatus;
directing the digital imaging apparatus toward the one of the participants; and
actuating the digital imaging apparatus.

3. The method of claim 2, wherein the step of storing the still digital image into a memory file of a digital computer further includes the step of downloading the still digital image from the digital imaging apparatus to the memory file.

4. The method of claim 1, wherein the step of generating a report of the still digital commercial image further includes the step of generating a hard copy of the still digital commercial image.

5. The method of claim 4, wherein the step of presenting the report to the spectators further includes the step of positioning the hard copy so that it may be viewed by the spectators.

6. The method of claim 1, wherein the step of generating a report of the still digital commercial image further includes the step of generating an electronic report of the still digital commercial image.

7. The method of claim 6, the spectators comprising remote on-line spectators viewing the activity through an on-line data link, wherein the step of presenting the report to the spectators further includes the step of transferring the electronic report into the on-line data link.

8. The method of claim 7, wherein the step of transferring the electronic report into the on-line data link further includes the steps of:
establishing a data transfer link between the computer and the on-line data link;
transferring the electronic report to the on-line data link over the data transfer link.

9. The method of claim 8, wherein the step of establishing a data transfer link further includes the step of establishing a hard communications link.

10. The method of claim 8, wherein the step of establishing a data transfer link further includes the step of establishing a remote communications link.

11. In a theatre including participants engaged in an activity and spectators observing the activity through an on-line data link, a method performed during the activity comprising the steps of:
gathering a still digital image of one of the participants;
storing the still digital image into a memory file of a digital computer;
with the digital computer, preparing a still digital commercial image incorporating the still digital image, the still digital commercial image capable of evoking a beneficial commercial impression;
generating a report of the still digital commercial image; and
transferring the report to the on-line data link.

12. The method of claim 11, wherein the step of gathering a still digital image of one of the participants further comprises the steps of:
providing digital imaging apparatus; and
directing the digital imaging apparatus toward the one of the participants; and
actuating the digital imaging apparatus.

13. The method of claim 12, wherein the step of storing the still digital image into a memory file of a digital computer further includes the step of downloading the still digital image from the digital imaging apparatus to the memory file.

14. The method of claim 11, wherein the step of generating a report of the still digital commercial image further includes the step of generating an electronic report of the still digital commercial image.

15. The method of claim 14, wherein the step of transferring the report to the on-line data link further includes the steps of:
establishing a data transfer link between the computer and the on-line data link;
transferring the electronic report to the on-line data link over the data transfer link.

16. The method of claim 15, wherein the step of establishing a data transfer link further includes the step of establishing a hard communications link.

17. The method of claim 15, wherein the step of establishing a data transfer link further includes the step of establishing a remote communications link.

18-26. (Canceled)
